(19) United States
(12) Patent Application Publication
(10) Pub. No.: US 2007/0050251 A1
(43) Pub. Date: Mar. 1, 2007

(54) Monetizing a preview pane for ads

(75) Inventors: Kamal Jain, Bellevue, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/214,272

(22) Filed: Aug. 29, 2005

(51) Int. Cl. G06Q 30/00

(52) U.S. Cl. 705/14

(57) ABSTRACT

The user interfaces, methods and systems described herein facilitate user interaction with an ad space by conveying additional advertising content via a preview pane and facilitate charging for this functionality. By way of example, a user is provided with one or more ads from a plurality of different advertisers in a first ad space maintained by an ad space supplier. A user input identifying at least one of the ads from the plurality of different advertisers is received and in response a second ad space having a supplemental ad relating to the at least one ad identified by the user input is provided. The advertiser associated with the supplemental ad is charged a fee based on receiving the user input. By way of another example, an electronic advertisement may be conveyed to a user in an ad space provided by a third party. A secondary advertisement providing associated information relating to the electronic advertisement may occur upon receiving a user indication. A monetizing component is available to determine the price of the electronic advertisement and/or the secondary advertisement.

### BACKGROUND

As ever increasing numbers of people turn to the Internet for information and goods/services, many advertisers have recognized the potential for increased profits through advertising online (e.g., in conjunction with web portal sites, search engine sites, and/or email services). Advertising on search engine sites has become popular because many businesses have recognized that an individual who is searching for information related to a particular product or service may be likely to purchase that product or service. For example, if a user enters the term “flower” into a search engine, that user may be interested in purchasing flowers. Thus, a flower retailer may seek to place an ad on the search engine site during the particular period of time when the term “flower” is utilized as a search term by one or more users.

To optimize revenue, ad space providers often restrict the style and size of ads placed on their sites in order to show as many ads as possible in an uncluttered manner. Consequently, an advertiser placing an ad on a third party advertising venue may be limited to only a text ad consisting of a small number of letters. Given the small size of such ads, a user may not get enough information to appropriately choose which ad to click to obtain the information/goods/services that best match the user's needs. If a user does not interact with an ad to purchase the goods/services offered by a vendor, this typically results in less revenue for both the ad space supplier and the vendor.

Thus, for the long term viability and growth of these online advertising ventures, it is important that ad space is utilized in an efficient manner and in a way that maximizes revenues for both the ad space operators and the advertisers. Therefore there exists a need to provide an interactive ad space that provides additional ad content without increasing clutter and that facilitates generating increased revenue.

### SUMMARY

This summary is not an extensive overview of the invention. It is not intended to identify key/critical elements of the invention or to delineate the scope of the invention. The sole purpose of this summary is to present some concepts relating to the invention in a simplified form as a prelude to the more detailed description that follows.

The user interfaces, methods and systems described herein facilitate a user's interaction with an advertiser and offer new and flexible pricing plans to serve a diverse group of advertisers. In one embodiment, a preview pane opens up when a user hovers a mouse pointer on an area of an online advertisement. The preview pane may be, for instance, a bubble having additional information about, links to and/or a preview of the vendor's web site and/or products or services offered for sale by the advertiser. The preview pane also may contain a navigation menu that allows a user to navigate the advertiser's web site. The preview pane also may provide additional working space, such as an order form to order products.

The preview pane has many advantages for ad space owners, users and advertisers. For instance, the preview pane allows users to quickly and easily abstract out the information they are interested in without adding clutter to the primary ad space. Unlike a pop-up ad, the preview pane allows the user to be in control of whether additional advertising information is presented. The preview pane can facilitate sales for the advertiser, which can lead to higher profits. By way of example, the preview pane may be used by an advertiser to provide a sales pitch to the user and, thus, entice the user to click over to the advertiser's site to place an order. This sales pitch may include such supplementary information as customer ratings and reviews, or the main business thrust of the merchant (e.g., full satisfaction guarantee or low prices, etc.). To further entice the user, an advertiser can provide a sample list of products and/or services available on its website, alone or together with prices and/or features. An advertiser also may use the preview pane to provide more targeted links in order to allow a user to quickly land on the page the user is interested in. By way of another example, an advertiser may provide a link that takes a user to a partially filled order page to order services/products offered by the advertiser (e.g., ordering a pizza, scheduling a doctor's appointment, etc.).

In one embodiment of an interactive user interface, an advertiser may provide a completely menu driven advertisement by enabling more hovering capability within the preview and navigation pane. For instance, a user may hover over the main ad and get a list of subclasses of the products, such as a list of categories. By way of example, if the advertiser is an electronics store, the subclasses may include video and audio, etc. In this example, if a user hovers over “audio,” the user is presented with another preview and navigation pane giving further subcategories, such as portable and full-size. The second preview pane may be enabled so that hovering over “portable” can present the user with further subcategories. This nested structure may continue on as necessary to preview and navigate the vendor's offerings.

Moreover, since viewing the preview pane requires either explicit or implicit user interaction of some sort, an advertiser can simply remove any link from the main ad and provide a link in the preview and navigation pane to reduce the likelihood of accidental/fraudulent clicks on its ad. This is particularly useful to the advertiser if the advertiser is paying by user interactions such as clicks. In addition, systems and methods of protecting an advertiser from accidental/fraudulent clicks or other user indications, such as CAPTCHA and other Human Interactive Proofs (HIPs), optionally may be utilized in the subject invention. By way of example, the user may be transferred to the vendor's site only when the user solves a puzzle that a human can solve rather easily but that a computer can take a long time to solve. This functionality serves to minimize the possibility that automated processes will enter the advertiser's site through the ad or that an advertiser will be charged for an accidental user indication.

The ad space supplier may provide tools to an advertiser to facilitate the creation of ads and preview panes. Exemplary tools are described in a commonly assigned patent application filed on Aug. 29, 2005, Attorney docket number MS314056.01/MSFTP1128US, entitled “AUTOMATICALLY GENERATING CONTENT FOR PRESENTING IN A PREVIEW PANE FOR ADS.”

The ad space supplier also may employ various mechanisms to monetize ads and preview panes. For instance, ad space suppliers may vary the fee for an ad based on the prominence of the ad placement. Because users are more likely to interact with ads placed more prominently in an ad space, advertisers understand the impact that ad placement has on their ability to generate sales though online advertising and thus, are willing to pay more for more prominent ads. To determine the prominence of ads in an advertising space, advertising space suppliers may conduct auctions.

By way of example, if the advertising space supplier is a search engine, an auction may be conducted to allow advertisers to bid for particular query words and/or phrases. Typically, online advertising is sold on a cost-per-click (CPC) basis such that the advertisers bid the amount that they are willing to pay each time a user clicks on their ad. An advertising space provider may award the most prominent ad space to the advertiser whose bid is the highest CPC bid. However, such an approach does not take into account the click-through-rate (CTR) (i.e., the probability that a user will click on the advertisement). Thus, another method that ad space providers may use to determine the placement of ads includes ascertaining the probability that a user will access the advertisement. For instance, the expected revenue (e.g., the product of the CPC and the CTR) may be determined and the ad yielding the most expected revenue may be given the most prominent placement. A more detailed discussion of systems and methods for auctioning online ad space, any and all of which are employable in the subject invention, are described in the commonly assigned U.S. patent application Ser. No. 10/977,824, filed on Oct. 29, 2004 and entitled “SYSTEMS AND METHODS FOR DETERMINING BID VALUE FOR CONTENT ITEMS TO BE PLACED ON A RENDERED PAGE.”

The user interfaces, systems and methods described herein are useful to charge advertising fees according to a secondary ad, such as a preview pane. By way of example, the fee an advertiser is charged may be determined per activation of the secondary ad (e.g., each hover over for a chargeable amount of time). By way of another example, an additional flat fee or an additional percentage fee may be charged for hovering capability and/or a different fee may be charged for user indications relating to content in the secondary ad relative to the primary ad activation fee. A different fee also may be charged for a menu-driven or multimedia secondary ad. If the fee is determined by an online ad auction, the winner of an auction may be chosen based on the probability that a user will activate a secondary ad (i.e., the activation rate). Moreover, to increase competition for the added functionality, the number of ad slots offering secondary ad capability may be restricted.

One example of a method of charging advertisers a fee for a second ad space comprises providing one or more ads from a plurality of different advertisers in a first ad space maintained by an ad space supplier, receiving a user input identifying at least one of the ads in the first ad space, providing a second ad space for a supplemental ad having supplemental advertising information relating to the ad identified by the user input and charging an advertiser associated with the supplemental advertising information a fee based on receiving the user input. The ad space supplier may be an email service, an application program, a web portal, and/or a search engine site. The user input may be a hover and the fee may be charged if the hover occurs for a minimum period of time. The fee associated with the second ad space may be a flat fee, a fee per activation, a fee per clip, a fee per print and/or a percentage fee. The percentage fee may be based on the fee paid by the advertiser for an ad provided in the first ad space. The advertiser associated with the supplemental advertising information may be charged each time the user input is received. The method may be encoded by computer-executable instructions stored on computer-readable media or transmitted in whole or in part by a manufactured data signal.

The method may further comprise determining the fee according to a competition among at least some of the plurality of different advertisers. The method also may further comprise limiting the number of second ad spaces available to the plurality of different advertisers participating in the competition. Determining the fee according to the competition among the plurality of different advertisers may comprise employing a probability that the user input will be received.

The method may further comprise receiving one or more additional user inputs relating to the supplemental ad. The one or more additional user inputs may activate one or more additional ad spaces and the fee may be determined according to the number of additional ad spaces activated by the additional user inputs. Determining the fee according to the number of additional ad spaces activated by the user inputs may comprise employing a probability that the one or more additional user inputs will be received.

One example of a system for monetizing a secondary advertisement activated by a user comprises an electronic advertisement conveyed to a user in an ad space provided by a third party, a secondary advertisement occurring upon receiving a user indication, and a monetizing component to determine the price of the secondary advertisement. The third party may be an email server, an application program, a web portal, and/or a search engine web page. The secondary advertisement may provide associated information relating to the electronic advertisement and relating to a vendor, thereby facilitating the user's interaction with the vendor. The monetizing component may determine the price of the secondary advertisement by an auction and the availability of the secondary advertisement may be restricted. The system may further comprise a tertiary advertisement occurring upon receiving a second user indication relating to the secondary advertisement. The monetizing component may further determine the price of the tertiary advertisement. The system may be conveyed in whole or in part by a manufactured data signal.

The secondary advertisement may be a menu of links, the user indication may be a hover over, and determining the price of the secondary advertisement may comprise determining a hover rate and a click-through-rate for each link in the menu of links. The hover rate may be associated with the likelihood the user indication will be received and the click-through-rate may be associated with the likelihood the user will click on the link in the menu of links.

One example of a system for determining a cost of advertising in a third party online advertising venue comprises means for providing online advertisements from two or more separate advertisers to a user interacting with the third party online advertising venue, means for providing a second advertisement, means for receiving a user indication from the user, and means for determining a cost of the second advertisement. The second advertisement may be associated with at least one of the online advertisements. The user indication may correspond to the online advertisement associated with the second advertisement. Upon receiving the user indication, the means for receiving the user indication signals the means for providing the second advertisement to provide the second advertisement and the means for providing the second advertisement provides the second advertisement to the user in response to the signal from the means for receiving the user indication.

The following description and the annexed drawings set forth in detail certain illustrative aspects of the subject invention. These aspects are indicative, however, of but a few of the various ways in which the principles of the subject invention may be implemented. Other advantages and novel features of the invention will become apparent from the following detailed description of the invention when considered in conjunction with the drawings.

### BRIEF DESCRIPTION OF THE DRAWINGS

FIG. 1A is a block diagram of one example of a user interface that facilitates user interaction with an advertisement.

FIG. 1B is a block diagram of the user interface of FIG. 1A at a later time.

FIG. 2 is an illustration of a standard ad space for providing electronic advertisements.

FIG. 3 is an illustration of one example of a user interface that facilitates user interaction with an advertisement.

FIG. 4A is another illustration of one example of a user interface that facilitates user interaction with an advertisement.

FIG. 4B is another illustration of one example of a user interface that facilitates user interaction with an advertisement.

FIG. 5 is another illustration of one example of a user interface that facilitates user interaction with an advertisement.

FIG. 6A is another illustration of one example of a user interface that facilitates user interaction with an advertisement.

FIG. 6B is yet another illustration of one example of a user interface that facilitates user interaction with an advertisement.

FIG. 7 is a flowchart representing one example of a method of providing online supplementary advertising information.

FIG. 8 is a flowchart representing another example of a method of providing online supplementary advertising information.

FIG. 9 is a block diagram of one example of a system for enhancing an advertising venue.

FIG. 10 illustrates an exemplary computing architecture that can be employed in connection with the subject invention.

FIG. 11 illustrates an exemplary networking environment that can be employed in connection with the subject invention.

FIG. 12 is a flowchart representing one example of a method of charging advertisers a fee for a second advertisement.

FIG. 13 is a flowchart representing another example of a method of charging advertisers a fee for a second advertisement.

FIG. 14 is a flowchart representing another example of a method of charging advertisers a fee for a second advertisement.

FIG. 15A is a block diagram of one example of a system for monetizing a secondary advertisement activated by a user.

FIG. 15B is a block diagram of the system of FIG. 15A at a later time.

FIG. 16A is a block diagram of another example of a system for monetizing a secondary advertisement activated by a user.

FIG. 16B is a block diagram of the system of FIG. 16A at a later time.

FIG. 17 is a block diagram of one example of a system for determining the cost of advertising in a third party online advertising venue.

FIG. 18A is an illustration of one example of a user interface that facilitates user interaction with an advertisement.

FIG. 18B is an illustration of another example of a user interface that facilitates user interaction with an advertisement.

### DETAILED DESCRIPTION

Various aspects of the subject invention are now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention. Although the methodologies are shown in the figures and described as a series of blocks, the subject invention is not limited by the order of the blocks, as some blocks may occur in different orders and/or concurrently with other blocks. Moreover, not all illustrated blocks may be required to implement the methodologies.

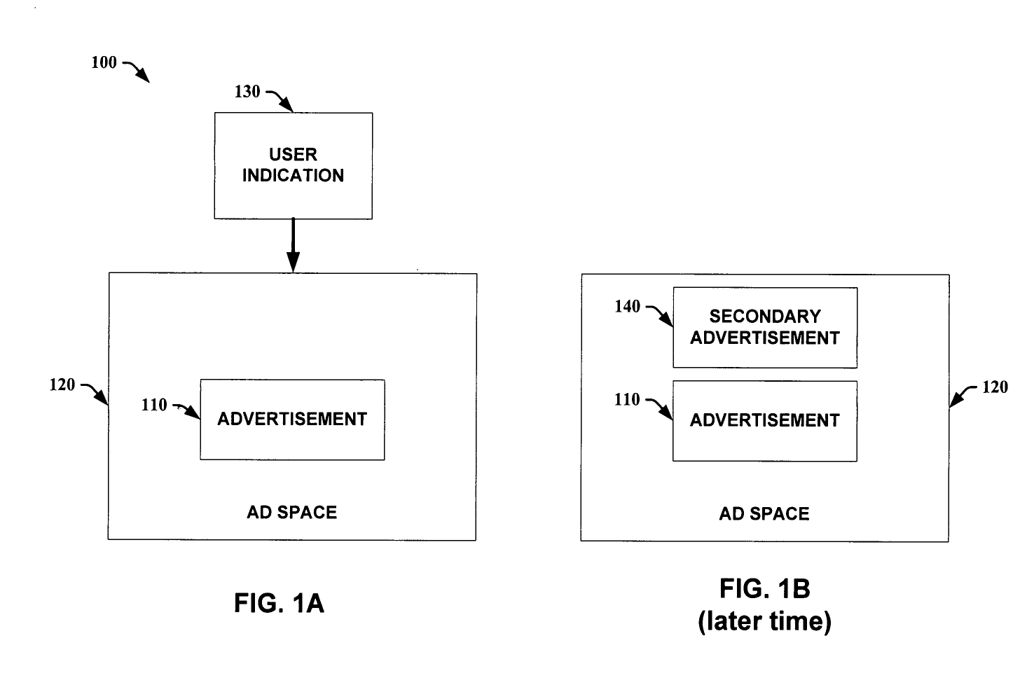

FIGS. 1A and 1B schematically illustrate one example of a user interface 100 that facilitates user interaction with a vendor shown at different times. The term vendor is used herein expansively to mean those entities offering for sale goods or services of all types, including both tangible and non-tangible goods, real property and intangible assets as well as services of any nature. The term vendor also is used herein to refer to entities that do not themselves make an offer for sale but provide a user with information or act as a conduit to route users to another entity. The term vendor also is used herein to refer to those entities that provide advertising services for others. Thus, the term vendor as used herein refers to any entity that desires to advertise for any reason.

The user interface 100 comprises an advertisement 110 presented to a user in an ad space 120. The advertisement 110 may be of any type including but not limited to visual, textual, graphical, photographic, audio, speech, video, multimedia and the like. The ad space 120 may be provided by a third party (i.e., a party other than the user or the vendor). The third party may be a web site, a search engine site, an application program, an email service, or any other third party site. A more detailed discussion of systems and methods for providing advertising in application programs, any and all of which are employable in the subject invention, are described in the commonly assigned U.S. patent application Ser. No. 11/139,750, filed on May 27, 2005 and entitled “ADVERTISING IN APPLICATION PROGRAMS.”

The user interface 100 may receive a user indication 130 and in response, provide a secondary advertisement 140. The user indication 130 may be an explicit user action, such as hovering an input device over the advertisement 110. The user indication 130 also may be a click of in input device or even speech. The input device may be, for example, a keyboard and/or a mouse and/or a microphone and the like. Other input devices currently existing and/or input devices yet to exist may be utilized to receive user indications 130 and are within the scope of the subject invention. For example, input devices to assess eye movement and gaze direction, thought processing, and/or body movement and the like, any of which, alone or in combination, may be used as input determinants. User indications 130 may also include implicit user actions. By way of example, artificial intelligence components may be employed to infer an implicit user indication 130. Such artificial intelligence components include but are not limited to neural networks, expert systems, Bayesian belief networks, fuzzy logic, data fusion engines and the like.

The secondary advertisement 140 may provide information associated with the advertisement 110. The associated information may include but is not limited to links to a landing page on the vendor's web site, audio content, video content, multimedia content and even a map to the vendor's place of business (e.g., provided by a MICROSOFT MAPPOINT LOCATION SERVER). By way of example, the secondary advertisement 140 may serve as a preview pane and provide links to navigate through the vendor's web site. By way of another example, the secondary advertisement may provide an order form that would allow the user to complete or partially complete a transaction with the vendor. In another aspect of the secondary advertisement 140, the order form, for instance, may be automatically fully or partially filled-in for the user.

The advertisements 110 and 140 may be, for example, online clickable advertisements that take a user to an entity's website. The advertisements 110 and 140 may also be interactive advertisements attached to, embedded in or otherwise conveyed by an email, an application program and the like. Thus, the subject invention is not limited to web portals and search engines. The advertisements 110 and 140 may also be non-visual enticements as well. By way of example, an audio advertisement may prompt a user to speak a certain word to land on the advertiser's site.

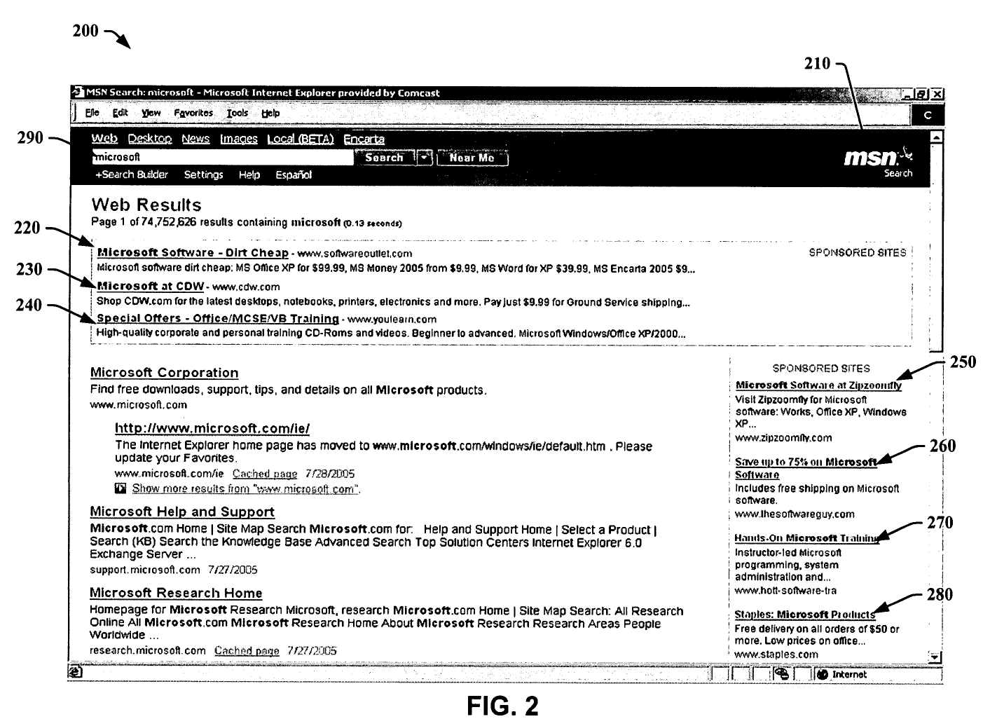

FIG. 2 is an illustration of a standard third party ad space 200 for providing advertisements. The third party 210 presents ads 220-280 to a user in response to a query 290. The third party 210 may charge a fee for an ad to be placed in the ad space 200, and this fee may be determined by a competition, such as an auction. More specifically, a search engine can receive a query 290 that includes one or more search terms that are of interest to a plurality of advertisers and the advertisers can place bids with respect to at least one of the search terms. By way of example, the bids may be based on the cost-per-click (CPC) rate and the click-through-rate (CTR). An advertiser associated with the highest bid may have its advertisement displayed upon a resulting page view. Auctioning advertising space associated with search terms is a substantial source of revenue for search engines, and because it directs users to an advertiser's products/services, can be a source of revenue for advertisers. A more detailed discussion of systems and methods for auctioning online ad space, any and all of which are employable in the subject invention, are described in the commonly assigned U.S. patent application Ser. No. 10/977,824, filed on Oct. 29, 2004 and entitled “SYSTEMS AND METHODS FOR DETERMINING BID VALUE FOR CONTENT ITEMS TO BE PLACED ON A RENDERED PAGE.”

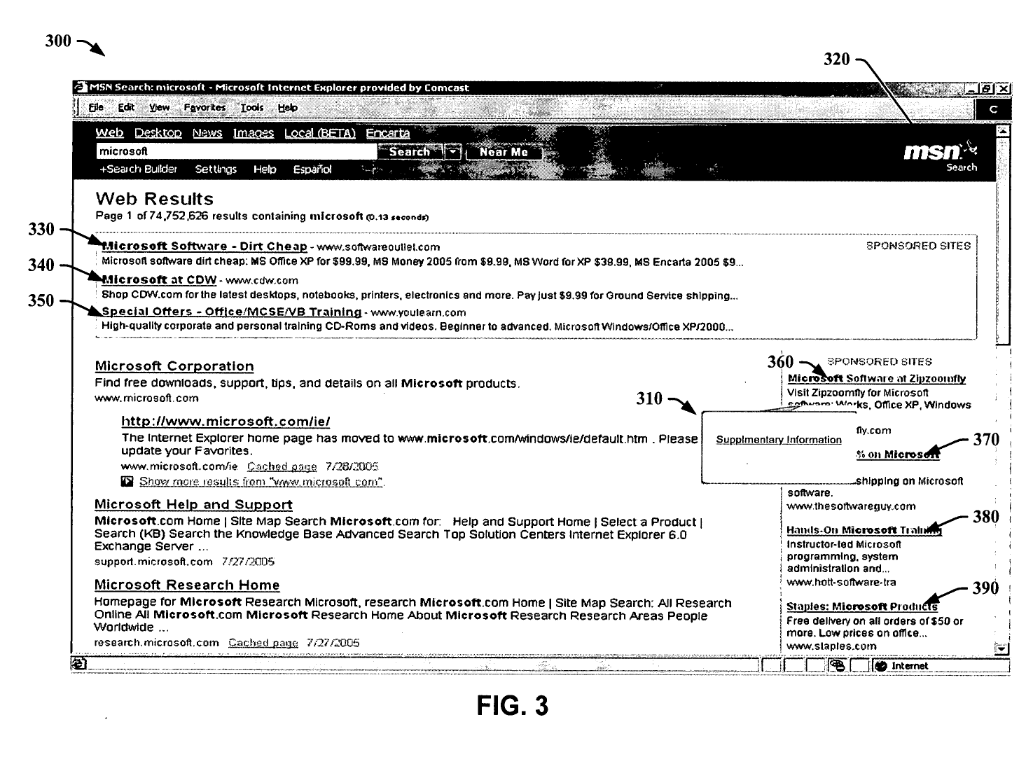

FIG. 3 is an illustration of one example of a user interface 300 that facilitates user interaction with an advertiser by providing supplementary information in a secondary advertisement 310 upon receiving a user indication. This secondary advertisement 310 serves to provide additional content in a user-controlled manner without adding clutter to the ad space. As shown, a third party 320 provides a user interface 300 to a plurality of advertisers 330-390. The advertisers 330-390 may be entities promoting products, goods and/or services of any type and nature regardless of whether the entity itself is providing the products, goods or services. For instance, the advertisers 330-390 may be entities that refer users to a vendor or otherwise provide advertising services to other entities. Moreover, the advertisers 330-390 are not limited to entities having an online presence. For instance, one or more advertisers 330-390 may be local businesses without web sites.

By way of example, a user may place a cursor (not shown) over an ad 360 and activate the secondary advertisement 310. As explained above, a variety of different input devices may be employed by a user to activate the secondary advertisement, such as a keyboard, touchscreen, or microphone, and the subject invention is not limited to this particular embodiment. Similarly, the secondary advertisement 310 is not limited to visual information and may be, for instance, audio or multimedia content.

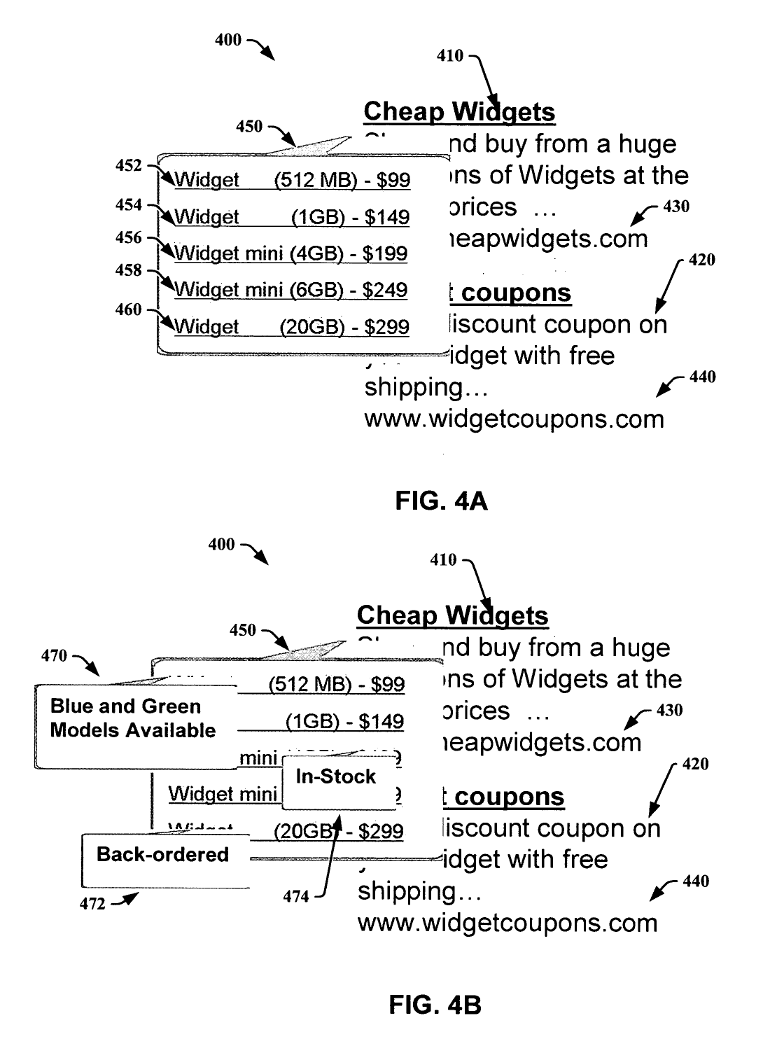

FIGS. 4A and 4B are other examples of an ad space 400 that facilitates user interaction with an advertisement. In these examples, the user is presented with ads 410 and 420 from a plurality of advertising entities 430 and 440. A supplemental advertisement 450 is displayed on user demand. As shown, the supplemental advertisement 450 provides additional information, such as model and price, about the products available for sale by the advertising entity 430. A user may navigate through an advertiser's online catalog quickly and easily by clicking on links 452-460 provided in the supplemental advertisement 450. A user also may obtain more additional information in tertiary ads 470-474 as shown in FIG. 4B. The tertiary ads 470-474 may be presented to the user simultaneously or in sequence and may be activated concurrently or successively. As in the previous examples, the user indications triggering the supplemental and tertiary ads may be of any type. Likewise, the supplemental and tertiary ads may be of any type. Furthermore, the ad space 400 may provide additional layers of ads and is not limited to three layers.

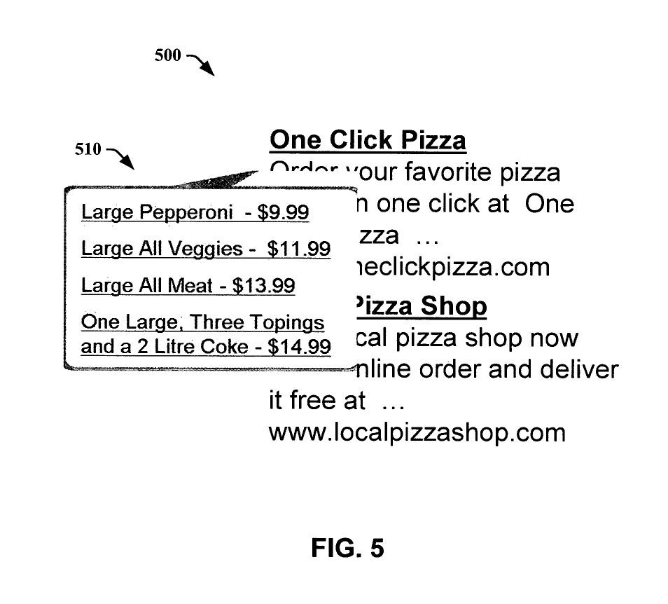

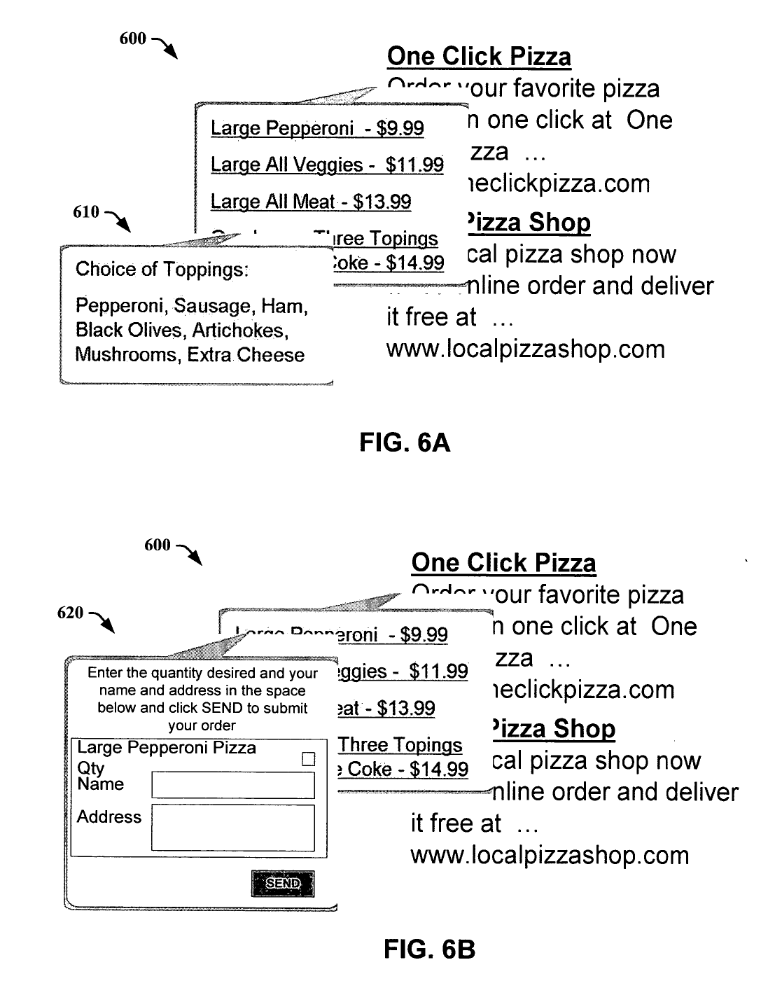

FIG. 5 is another illustration of one example of a user interface 500 that facilitates user interaction with an advertisement. FIGS. 6A and 6B show additional functionality of the user interface. As shown in FIG. 5, a user may receive a second advertisement 510 by providing an input (not shown). The second advertisement may include product and price information and this may entice a user to purchase the advertiser's goods and/or services. The user may provide an additional indication (not shown) to obtain a third advertisement 610 as illustrated in FIG. 6A. The user interface 600 can provide a fourth, a fifth, and a sixth ad, etc. in a similar fashion. The user interface 600 is not limited in the number of ads it can provide and may be configured to provide any number of levels of advertisements. Moreover, each nested ad may be of the same or of different types, for instance, a mixture of text, audio, and pictures. As shown in FIG. 6B, a third advertisement may be an order form 620 that allows a user to order a product from the advertiser. The order form may be completely or partially filled-in by the user interface 600 to facilitate the purchase. This feature is particularly valuable to advertisers who do not maintain their own web sites to allow them to provide online ordering functionality.

The user interfaces described above may be conveyed on a network, in whole or in part, by data signals. These manufactured data signals may be of any type and may convey the user interfaces on any type of network. For instance, the user interfaces may be conveyed by electronic signals propagating on electronic networks, such as the Internet. Wireless communications techniques and infrastructures also may be utilized to convey the user interfaces.

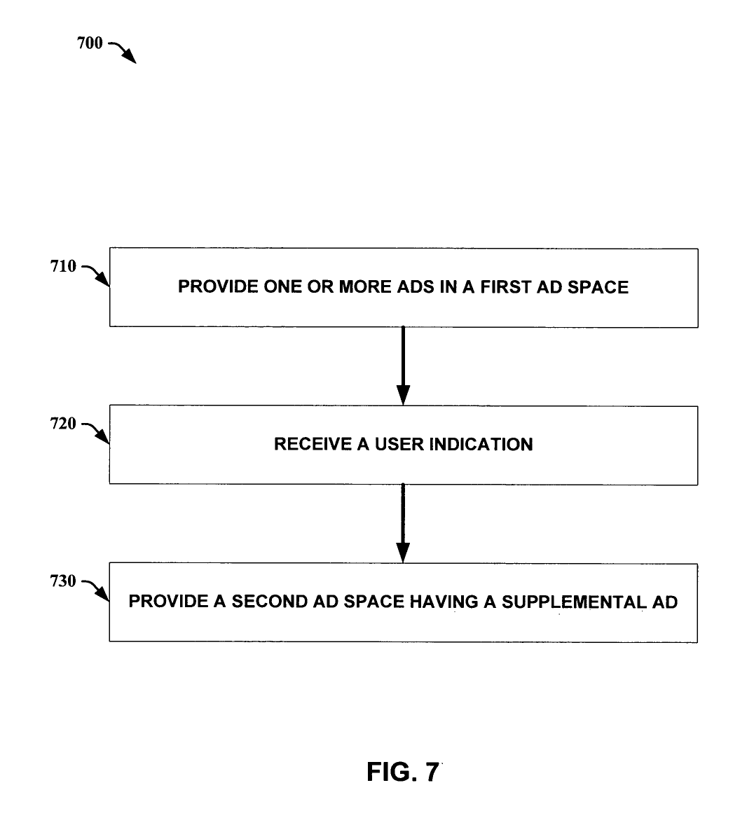

FIG. 7 is a flowchart representing one example of a method 700 of providing supplementary online advertising information. At step 710, one or more ads from a plurality of different advertisers are provided to a user in a first ad space maintained by an ad space supplier. By way of example, the ad space supplier may be an entity such as http://www.msn.com providing ad spaces such as those shown in FIGS. 1-6. At step 720, a user input identifying at least one of the ads is received. In response to the user input, the method proceeds to step 730 and a second ad space having a supplemental ad relating to the initial ad is provided. All types of user inputs (e.g., hover, click, speech, eye gaze, etc.) may be utilized in the method and any type of supplemental ad (e.g., web site preview, links, map, audio, video, multimedia, etc.) may be provided in response to the input. The method 700 may be implemented by computer-executable instructions stored on computer-readable media or conveyed by a data signal of any type.

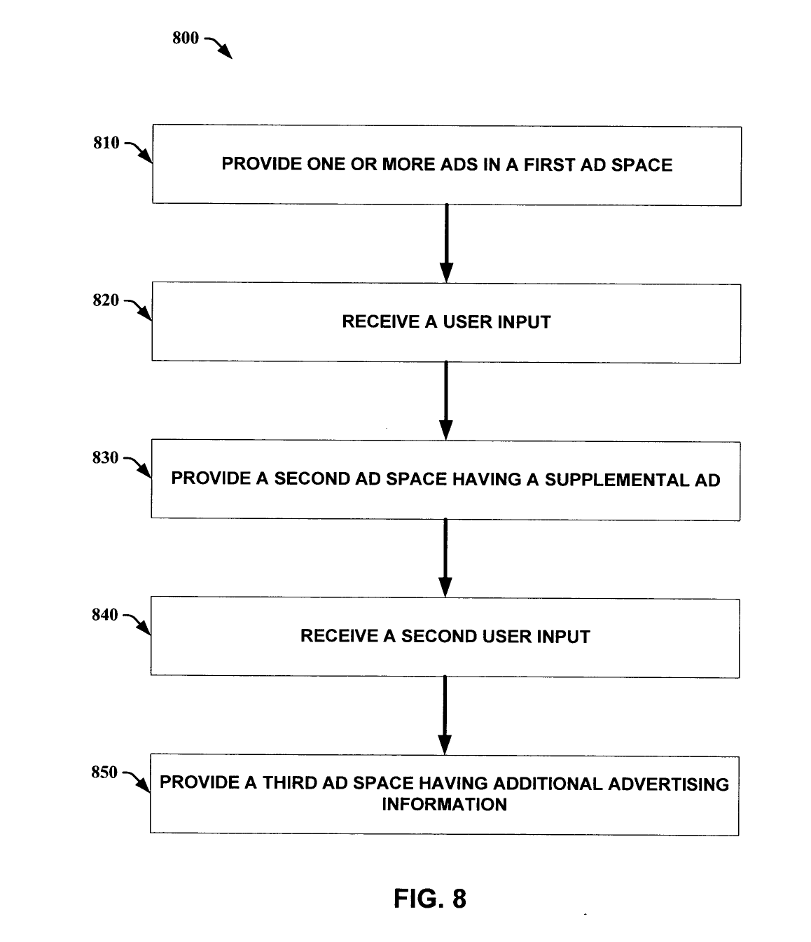

FIG. 8 is a flowchart representing another example of a method 800 of providing supplementary online advertising information. At step 810, one or more ads corresponding to different advertisers are provided in a first ad space. Upon receiving a first user input indicating a particular ad at step 820, a second ad space is provided at step 830. Upon receiving a second user input at step 840, a third ad space is provided at step 850. The process 800 may continue on to provide a fourth, a fifth, a sixth ad space, etc. and is not limited to the number of steps shown in FIG. 8. All types of user inputs (e.g., hover, click, speech, eye gaze, etc.) may be utilized in the method and any type of supplemental ad and additional advertising information (e.g., web site preview, links, map, audio, video, multimedia, etc.) may be provided in response to the input. The method 800 may be implemented by computer-executable instructions stored on computer-readable media or conveyed by a data signal of any type.

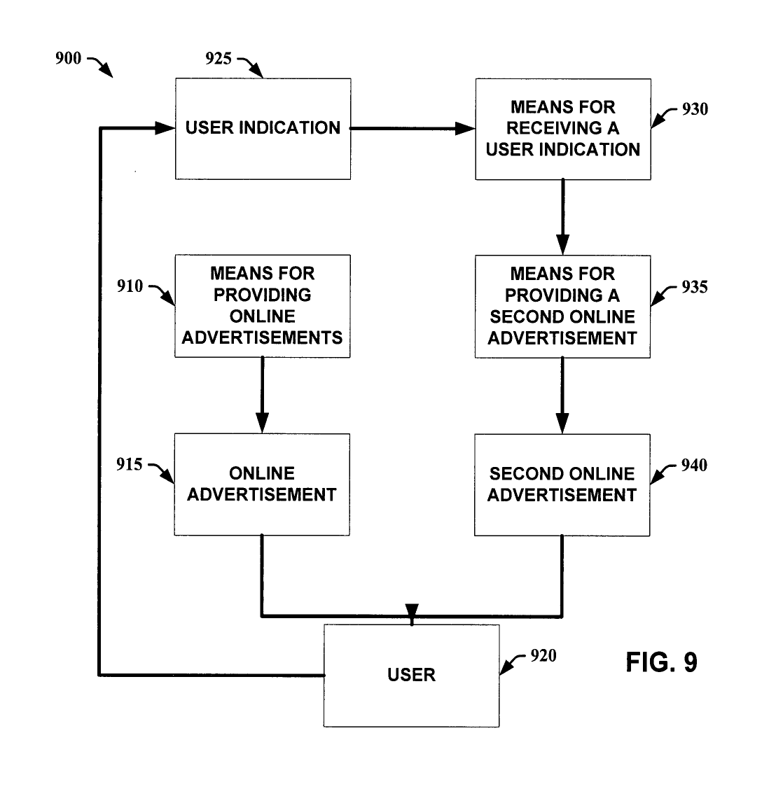

FIG. 9 is a block diagram of one example of a system 900 for enhancing an advertising venue. As shown, the means for providing online advertisements 910 provides an online advertisement 915 to a user 920. The means for providing online advertisements 910 may provide online advertisements from two or more separate advertisers, for instance, as shown in the figures corresponding to the exemplary user interfaces described above. Upon receiving the online advertisement 915, the user 920 may provide a user indication 925 indicating that the user 920 desires more information. The user indication 925 is received by the means for receiving the user indication 930, which signals the means for providing a second online advertisement 935 to provide a second online advertisement 940 to the user 920. The second online advertisement 940 may generally or more specifically relate to the online advertisement 915 and be of any type and provided in any manner. The system 900 may be expanded to provide any number of additional ads relating generally or more specifically to either the online advertisement 915 or the second online advertisement 940. The system 900 may be conveyed by a data signal of any type.

As used in this application, the term “means” is intended to refer to a computer-related entity, either hardware, a combination of hardware and software, software, or software in execution. For example, a means may be, but is not limited to being, a process running on a processor, a processor, an object, an executable, a thread of execution, a program, and/or a computer. By way of illustration, both an application running on a server and the server can be a means. One or more means may reside within a process and/or thread of execution and a means may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The subject invention may operate in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents. One or more components may reside within a process and/or thread of execution and a component may be localized on one computer and/or distributed between two or more computers.

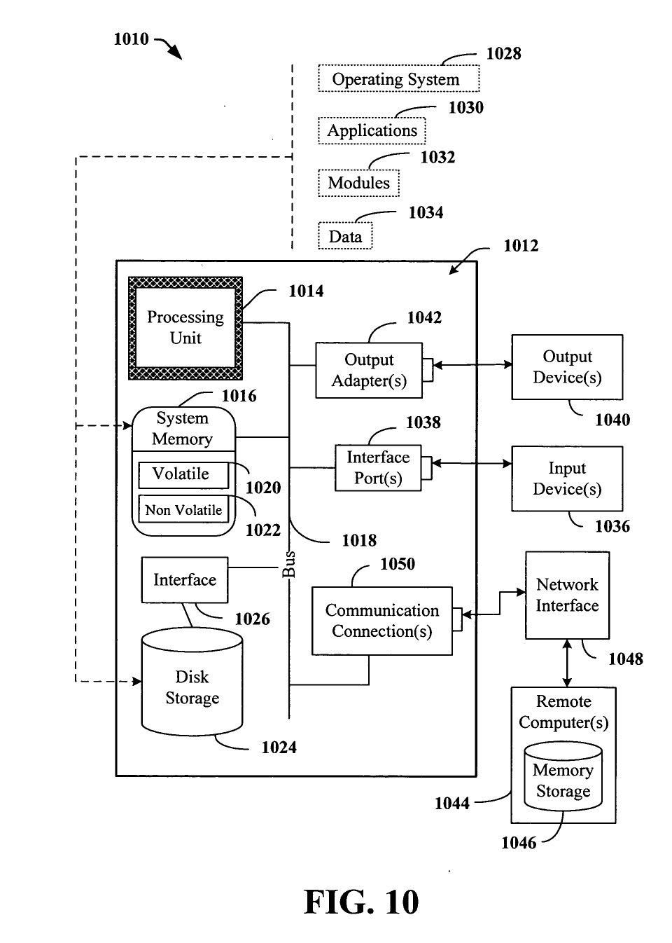

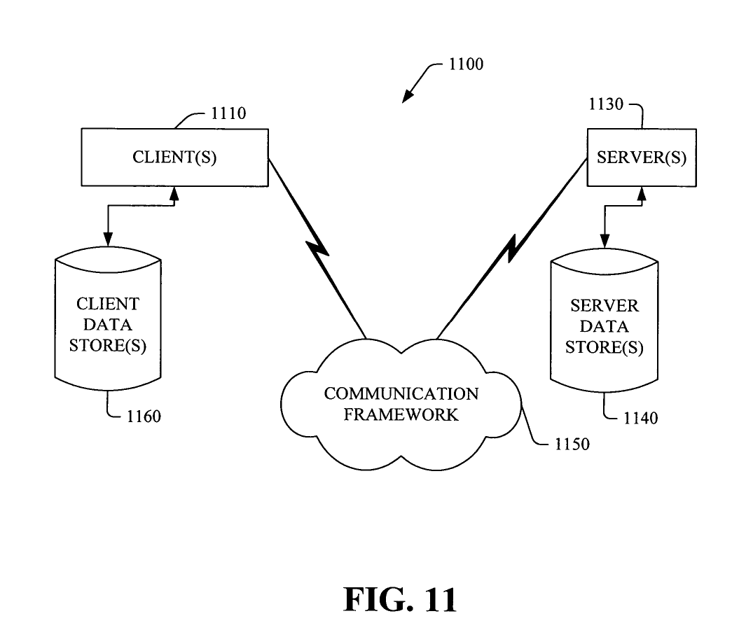

In order to provide a context for the various aspects of the invention, FIGS. 10 and 11 as well as the following discussion are intended to provide a brief, general description of a suitable computing environment in which the various aspects of the user interfaces, methods and systems described herein may be implemented. Although the description above relates to the general context of computer-executable instructions of a computer program that runs on a computer and/or computers, those skilled in the art will recognize that the user interface, methods and systems also may be implemented in combination with other program modules. Generally, program modules include routines, programs, components, data structures, etc. that perform particular tasks and/or implement particular abstract data types.

Moreover, those skilled in the art will appreciate that the user interfaces, methods and systems described herein may be practiced with other computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules may be located in both local and remote memory storage devices. The user interface, methods and systems described herein may be embodied on a computer-readable medium having computer-executable instructions for implementing various aspects of the subject invention as well as signals manufactured to transmit such information, for instance, on a network.

FIG. 10 schematically illustrates an exemplary environment 1010 for implementing various aspects of the subject invention. The environment 1010 includes a computer 1012, which includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and Rambus Direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage device 1024. Disk storage device 1024 includes, but is not limited to, devices like a magnetic disk drive, floppy disk drive, tape drive, Jaz drive, Zip drive, LS-100 drive, flash memory card, or memory stick. In addition, disk storage device 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

In addition to hardware components, FIG. 10 illustrates software that acts as an intermediary between users and the basic computer resources described in suitable operating environment 1010. Such software includes an operating system 1028. Operating system 1028, which can be stored on disk storage devices 1024, acts to control and allocate resources of the computer system 1012. System applications 1030 take advantage of the management of resources by operating system 1028 through program modules 1032 and program data 1034 stored either in system memory 1016 or on disk storage devices 1024. The subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the user interfaces, methods and systems described herein. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 can connect to one or more client data store(s) 1160 that can be employed to store information local to the client(s) 1110. Similarly, the server(s) 1130 can connect to one or more server data store(s) 1140 that can be employed to store information local to the servers 1130.

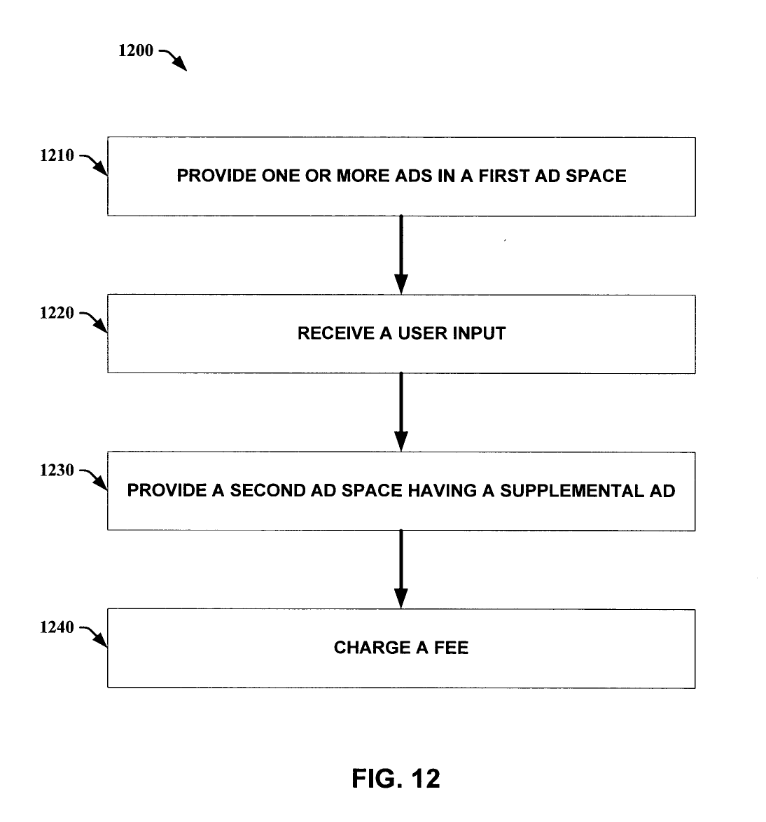

FIGS. 12-14 are flowcharts representing examples of methods 1200-1400 of charging advertisers a fee for a second advertisement. The methods provide novel and flexible pricing plans to better accommodate diverse advertisers. By presenting information to users in a more organized manner, the secondary ads provide users with a more efficient way to search ads and increase the possibility that a user will interact with an ad. Thus, the added functionality both increases the possibility of a sale by a vendor and increases the possibility of a chargeable user input, which further serves to optimize an ad supplier's revenue.

Regarding the method illustrated in FIG. 12, at step 1210 one or more ads from a plurality of advertisers are provided in a first ad space maintained by an ad space supplier. The ads may be of any type including but not limited to visual, textual, graphical, photographic, audio, speech, video, multimedia and the like. The ad space supplier may be an email service, an application program, a web portal, a search engine site or any other third party site.

Upon receiving a user input identifying at least one of the ads in the first ad space at step 1220, a second ad space for a supplemental ad having supplemental advertising information relating to the identified ad is provided at step 1230. The user input may be an explicit user action, such as hovering an input device over the ad. The user input also may be a click of an input device or even speech. The input device may be, for example, a keyboard and/or a mouse and/or a microphone and the like. Other input devices currently existing and/or input devices yet to exist may be utilized to receive user inputs and are within the scope of the subject invention. For example, input devices to assess eye movement and gaze direction, thought processing, and/or body movement may be used to convey a user indication. User inputs also may include implicit user actions. By way of example, artificial intelligence components may be employed to infer an implicit user input. Such artificial intelligence components include but are not limited to neural networks, expert systems, Bayesian belief networks, fuzzy logic, data fusion engines and the like.

By way of another example, the supplemental advertising information may include but is not limited to links to a landing page on the vendor's web site, audio content, video content, multimedia content, a map to the vendor's place of business (e.g., provided by a MICROSOFT MAPPOINT LOCATION SERVER), a menu to navigate the advertiser's web site, a featured listing from the advertiser's site, current inventory available on the advertising entity's site, driving directions, and an advertiser's rating and/or customer feedback.

By way of another example, the second ad may provide additional workspace, such as an order form that would allow the user to complete or partially complete a transaction with the advertiser. The order form, for instance, may be automatically fully or partially filled-in for the user. By way of yet another example, the order information may be sent to the advertiser by email, fax, phone or any other communications means. The second ad space may be cryptographically secure, for instance, to facilitate receiving payment from the user for the order. Payment may be received in any form including but not limited to credit card, debit card, check, automatic clearing house (ACH) transfer, or an email-based payment system such as PAYPAL. Thus, the second ad space may provide online ordering functionality for an advertising entity that does not have an online presence (e.g., local and small businesses).

At step 1240, an advertiser associated with the supplemental advertising information is charged a fee based on receiving the user input. The fee associated with the second ad space may be a flat fee and/or a percentage fee. By way of example, a flat fee or a percentage fee may be charged for providing second ad space functionality (e.g., hovering capability). The percentage fee may be calculated, for instance, as a percentage of the fee paid for an ad placed in the first ad space. The fee may be charged each time the second ad is activated (e.g., clicked, hover over) or by some other mechanism. For instance, if the user input is a hover, the fee may be charged if the hover occurs for a minimum period of time (i.e., a chargeable activation).

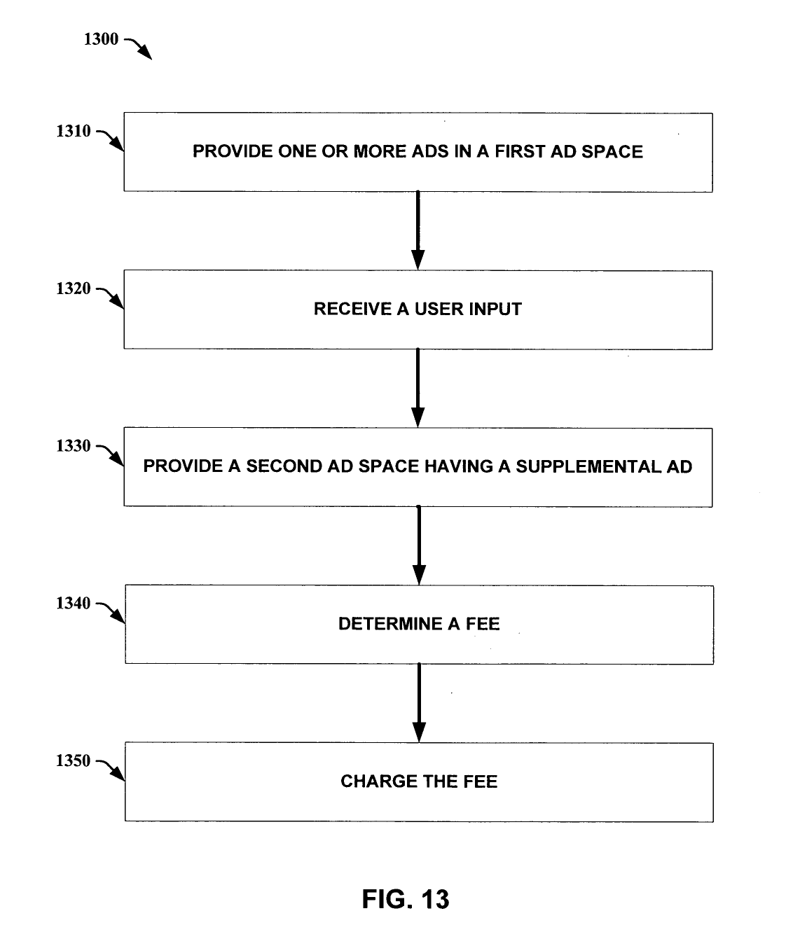

FIG. 13 is a flowchart of another example of a method 1300 of charging an advertiser for a second ad space. At step 1310 one or more ads from a plurality of advertisers are provided in a first ad space maintained by an ad space supplier. Upon receiving a user input identifying at least one of the ads in the first ad space at step 1320, a second ad space for a supplemental ad having supplemental advertising information relating to the identified ad is provided at step 1330. At step 1340, the fee the advertiser is to be charged is determined and at step 1350, the advertiser is charged this fee. Step 1340 is not limited to the sequence show in FIG. 13. For instance, step 1340 may occur prior to step 1310, after step 1310, after step 1320, during the occurrence of steps 1310-1330 or may occur both prior to step 1310 and during steps 1310-1330. As discussed in relation to FIG. 12, the ads, supplemental advertising information and user inputs may be of any type and the ad space supplier may be any third party.

By way of example, the fee may be determined by holding a competition event. This competition may be, for instance, an online ad auction. Exemplary systems and methods for auctioning online ad space, any and all of which are employable in the subject invention, are described in the commonly assigned U.S. patent application Ser. No. 10/977,824, filed on Oct. 29, 2004 and entitled “SYSTEMS AND METHODS FOR DETERMINING BID VALUE FOR CONTENT ITEMS TO BE PLACED ON A RENDERED PAGE.” In order to increase the competition for the second ad space functionality, by way of yet another example, the availability of the second ad space may be limited to only a few ads in the first ad space.

The fee may be determined at least in part by calculating the expected revenue for an ad. One way the expected revenue may be ascertained is by employing a probability a user will activate the ad. For instance, the expected revenue for an ad having the capacity to provide a supplemental ad may be calculated by determining the cost-per-activation (CPA) of the ad and multiplying this by the likelihood the ad will be activated. The likelihood the ad will be activated may be estimated by a probability. For instance, if the user input is a chargeable hover over, one way to determine the expected revenue is to calculate the product of the probability the user will hover over the ad (i.e., the hover rate) and the CPA.

By way of another example, the second ad space may be divided into portions and the performance of each portion of the second ad space may be tracked over time. This information may be employed to further determine the expected revenue. For instance, the second ad space may provide multiple incidences of supplemental advertising information. In one example, the supplemental advertising information may be a series of clickable links displayed in the supplemental ad. The rate at which each link is activated may be tracked to determine the click-through-rate (CTR) for that link. The expected revenue of the second ad space may be calculated by multiplying the CTR of each link by the CPA of each link. At auction, the advertisers' bids may be ordered according to the expected revenue to determine the advertiser whose bid is expected to generate the most revenue. That advertiser may win the competition and be charged according to their bid or some other fee, for instance, according to the bid expected to generate the second most revenue.

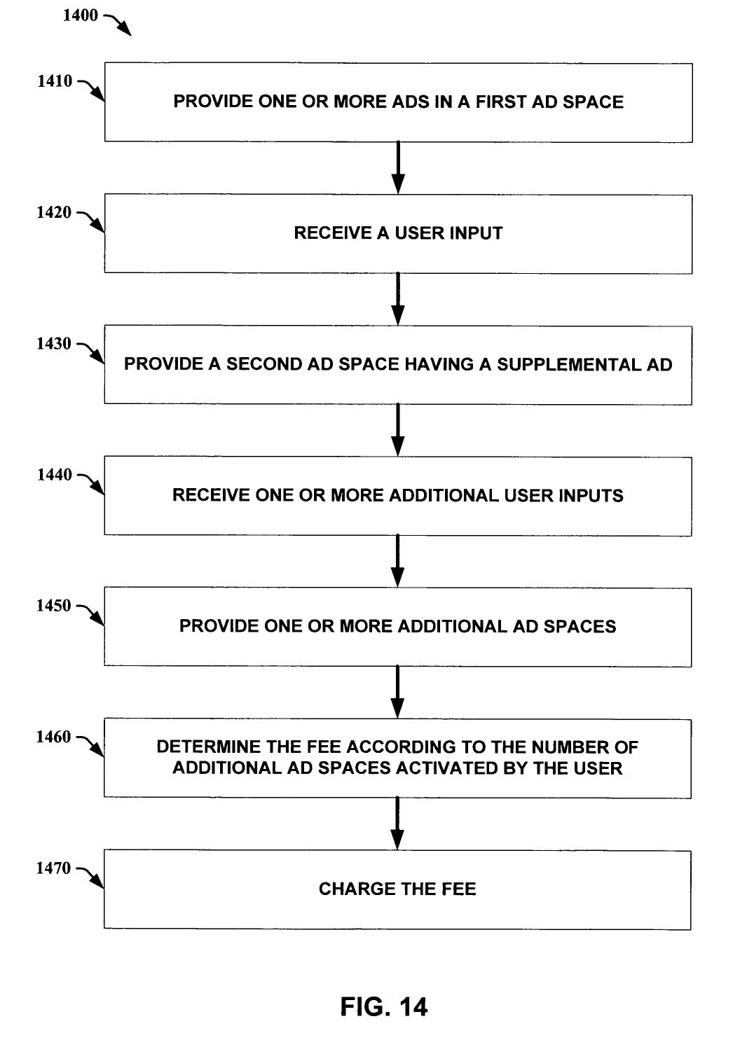

FIG. 14 is a flowchart of another example of a method 1400 of charging an advertiser for a second ad space. At step 1410 one or more ads from a plurality of advertisers are provided in a first ad space maintained by an ad space supplier. Upon receiving a user input identifying at least one of the ads in the first ad space at step 1420, a second ad space for a supplemental ad having supplemental advertising information relating to the identified ad is provided at step 1430. At step 1440, one or more additional user inputs relating to the supplemental ad are received. The one or more additional user inputs activate one or more additional ad spaces and at step 1450, these one or more additional ad spaces are provided. Thus, the method 1400 may provide for a menu driven ad.

At step 1460, the fee the advertiser is to be charged is determined according to the number of additional ad spaces activated by the one or more user inputs. At step 1470, the advertiser is charged this fee. Step 1460 may occur in sub-steps and is not limited to the sequence shown in FIG. 14. For instance, step 1460 may occur in part prior to step 1410 or may occur in part both prior to step 1410 and during steps 1410-1450. Thus, the method 1400 provides for a nested fee structure, for instance, one in which the fee for a menu driven ad is determined by the number of levels accessed by a user. The fee for each level of the supplemental ad unraveled by the user may be different or uniform and may be different from or the same as the fee charged for placing the ad in the first ad spaced. Moreover, all of the fees charged to an advertiser may be determined in whole or in part by one or more of the processes described in relation to FIGS. 12 and 13. As also discussed in relation to FIG. 12, the ads, supplemental advertising information and user inputs may be of any type and the ad space supplier may be any third party. As also discussed in relation to FIG. 13, the fee may be of any type and be determined by any suitable method, such as by a competitive event.

All of the methods of the subject invention may be implemented, in whole or in part, by computer-executable instructions that may be stored on computer-readable media. Moreover, the computer-executable instructions may be transmitted on a network, in whole or in part, by data signals. These data signals may be of any type and may transmit the systems on any type of network. For instance, computer-executable instructions for performing the methods may be conveyed by electronic signals propagating on electronic networks, such as the Internet. Wireless communications techniques and infrastructures also may be utilized to convey the computer-executable instructions.

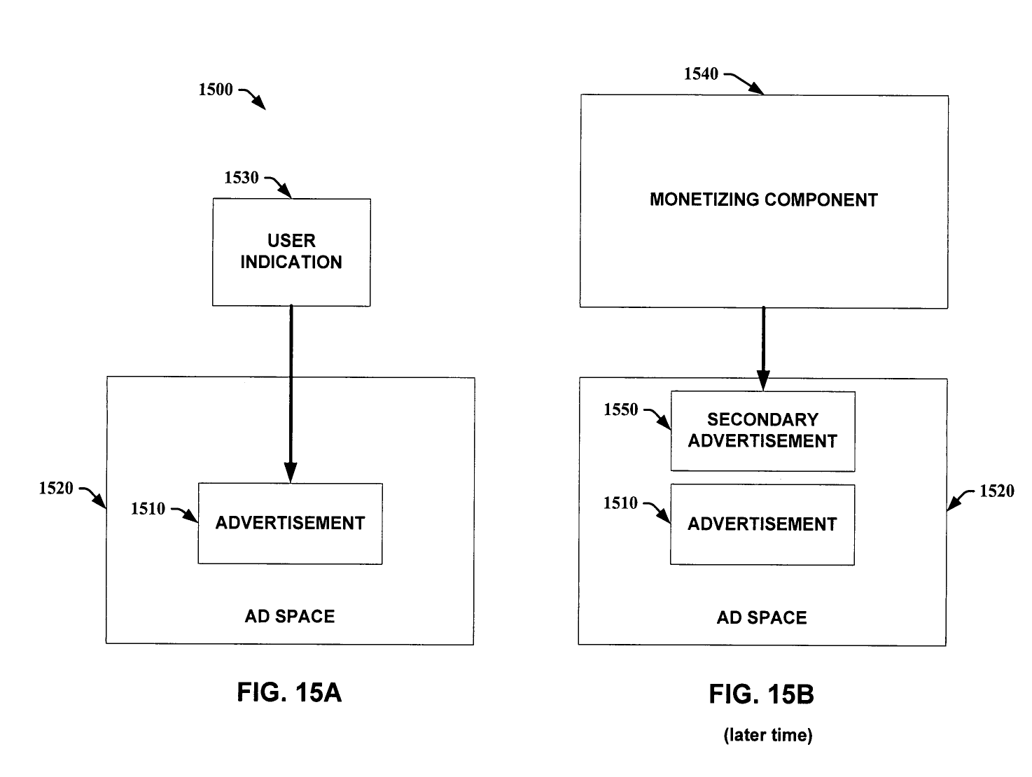

FIGS. 15A and 15B are block diagrams of one example of a system 1500 for monetizing a secondary advertisement 1550 activated by a user shown at an earlier (FIG., 15A) and a later (FIG. 15B) time. The system 1500 conveys an electronic advertisement 1510 to a user (not shown) in an ad space 1520 provided by a third party. Upon receiving a user indication 1530, a secondary advertisement 1550 is generated. The system 1500 also has a monetizing component 1540. The monetizing component 1540 serves to optimize the revenue generated by the ad space 1520, for instance, by providing a flexible pricing plan. By way of example, the price may be determined by an advertising auction. As discussed in relation to FIG. 12, the advertisements, associated information and user indication may be of any type and the third party may be any suitable third party. The flexible pricing plan may be determined in whole or in part by one or more of the processes described in relation to FIGS. 12 and 13.

By way of another example, the availability of the secondary advertisement 1550 may be restricted such that only a certain number of electronic advertisements 1510 are capable of conveying a secondary advertisement 1550. The system 1500 also may provide a third, a fourth, a fifth, a sixth, etc. level of advertisements, and is not limited in the number of levels of advertisements it can provide. The price for each level of advertisements activated by the user may be different or uniform and may be different from or the same as the price for placing the electronic advertisement 1510 in the ad space 1520. Moreover, the pricing plan may be determined in whole or in part by one or more of the processes described in relation to FIGS. 12 and 13.

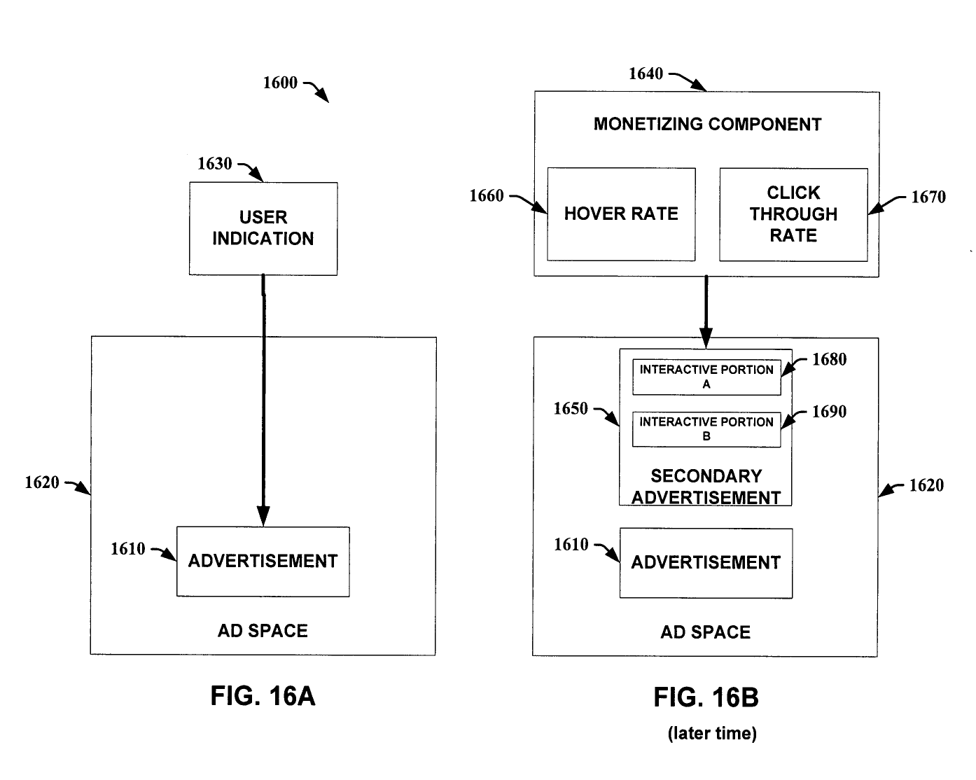

FIGS. 16A and 16B are block diagrams of another example of a system 1600 for monetizing a secondary advertisement 1650 activated by a user shown at an earlier (FIG. 16A) and a later (FIG. 16B) time. In this exemplary system 1600, the monetizing component 1640 utilizes a hover rate (HR) 1660 and a click-through-rate (CTR) 1670 to optimize the price of the advertisements 1610 and 1650. For instance, the hover rate 1660 may be derived from the probability that a user will hover over the electronic advertisement 1610 for a chargeable amount of time. The CTR 1670 may be derived from the probability that the user will activate the interactive portions 1680 and 1690 of the secondary advertisement 1650.

The HR 1660 and the CTR 1670 may be combined with other variables, such as a cost-per-access (CPA) (not shown), to determine the price of the advertisements 1610 and 1650. By way of example, the product of the HR 1660 and the CPA of the secondary advertisement 1650 may be used to determine the price of activating the secondary advertisement 1650. Likewise, the product of the CTR 1670 and the CPA for each interactive portion 1680 and 1690 of the secondary advertisement 1650 may be used to determine the price of activating the interactive portions 1680 and 1690 of the secondary advertisement 1650. The interactive portions 1680 and 1690 of the secondary advertisement 1650 may be priced individually or collectively, and the price of each may be the same as or different from each other and/or the price of placing the advertisement 1610 and/or activating the secondary advertisement 1650. The interactive portions 1680 and 1690 of the secondary advertisement 1650, for instance, may be a menu of links that the user may interact with (e.g., by click) to land on one or more pages of the vendor's web site. The system 1600 also may provide a third, a fourth, a fifth, a sixth, etc. level of advertisements, and the price may be determined by the number of levels accessed by the user. The system 1600 is not limited in the number of levels of advertisements it can provide. Moreover, the pricing plan may be determined in whole or in part by one or more of the processes described in relation to FIGS. 12 and 13.

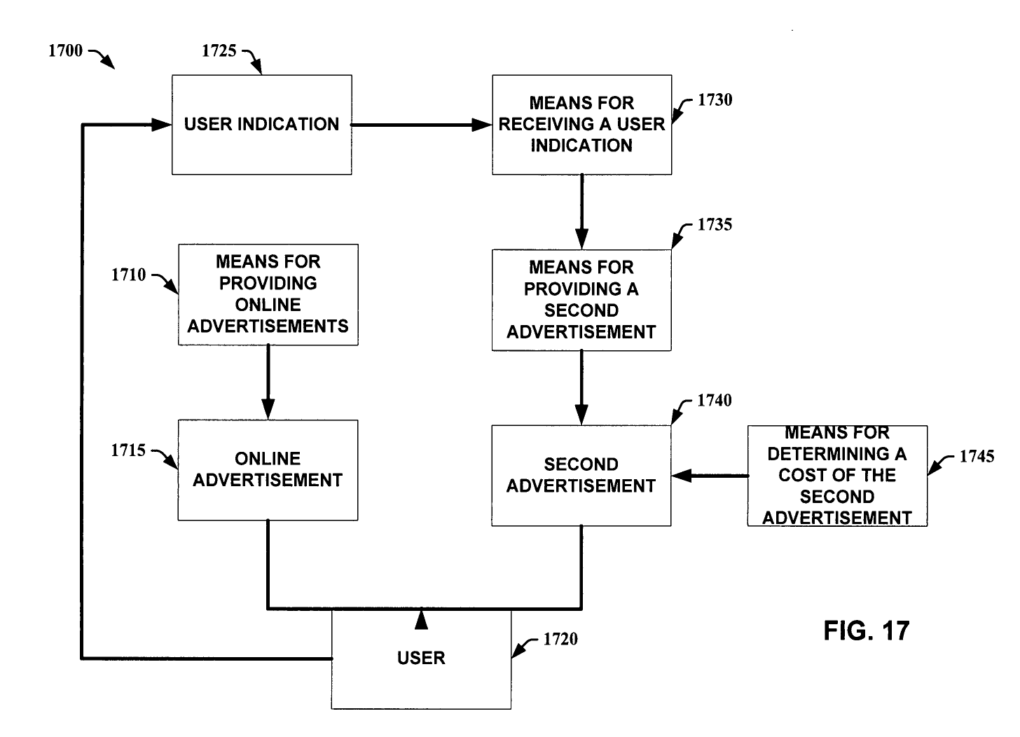

FIG. 17 is a block diagram of one example of a system 1700 for determining the cost of advertising in a third party online advertising venue. The system 1700 comprises means for providing online advertisements 1710 to provide an online advertisement 1715 to a user 1720 interacting with the third party online advertising venue. The means for providing online advertisements 1710 may provide online advertisements from two or more separate advertisers, for instance, as shown in the figures corresponding to the exemplary user interfaces described above. A user 1720 may interact with the online advertisement 1715 and convey a user indication 1725 corresponding to the online advertisement 1715 to the means for receiving a user indication 1730. Upon receiving the user indication 1725, the means for receiving the user indication 1730 may signal the means for providing a second advertisement 1735 to provide a second advertisement 1740 relating to the advertisement 1715 indicated by the user 1720. The system 1700 further comprises means for determining a cost of the second advertisement 1745. The means for determining a cost of the secondary advertisement 1745 may determine the cost according to one or more of the processes described above in relation to FIGS. 12-16. Moreover, the system 1700 may be expanded to provide any number of additional ads relating generally or more specifically to either the online advertisement 1715 or the second advertisement 1740.

All of the systems of the subject invention may be conveyed on a network, in whole or in part, by data signals. These data signals may be of any type and may transmit the systems on any type of network. For instance, the systems may be conveyed by electronic signals propagating on electronic networks, such as the Internet. Wireless communications techniques and infrastructures also may be utilized to convey the systems.

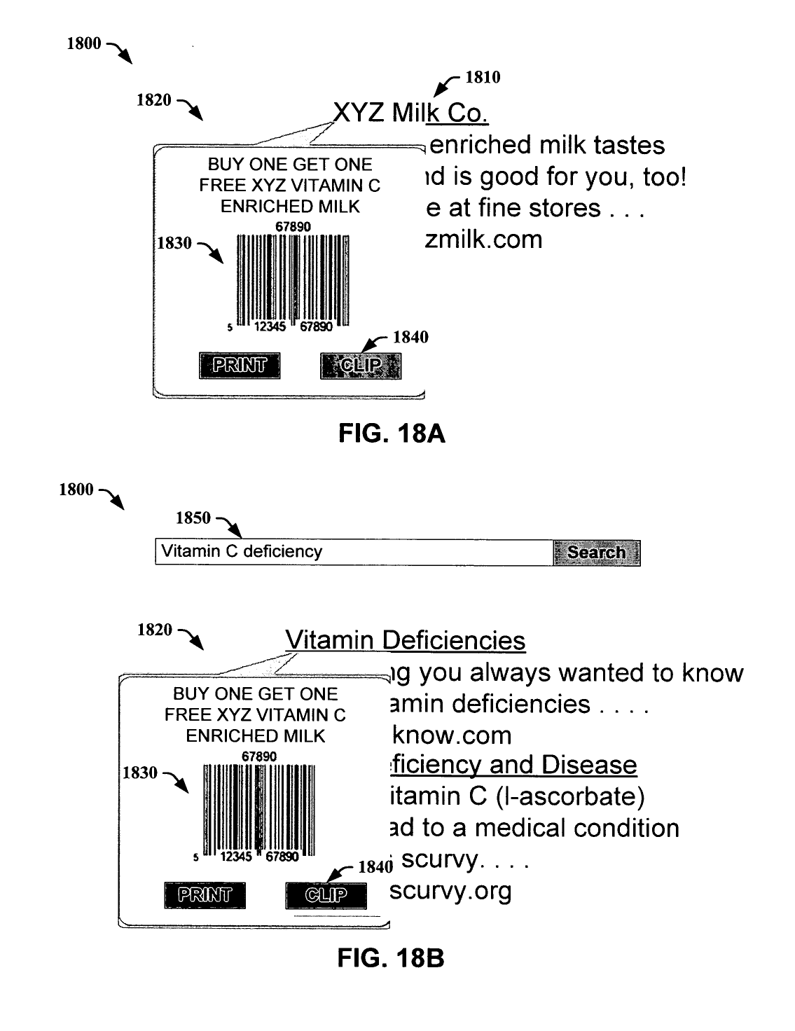

FIGS. 18A and 18B illustrate other examples of user interfaces 1800 that facilitate user interaction with an advertisement. As shown in FIG. 18A, a user may interact with a first advertisement 1810 to receive a second advertisement 1820. The second advertisement 1820 may include a coupon code 1830 that the user may print to take to a vendor to receive a discount when purchasing the advertiser's goods and/or services. Thus, the user interfaces 1800 may facilitate offline commerce. A user may also store the coupon 1830 to print later, for instance, by hitting the “clip” button 1840, which facilitates storing the coupon 1830 to print later. This functionality allows a user to clip several coupons and print them out together rather than printing them one at a time. As shown in FIG. 18B, a coupon code 1830 also may be presented to a user via a preview pane 1820 when a user enters a query 1850 that relates to the coupon 1830. The advertiser may be charged a fee for the coupon functionality 1830. For instance, the fee may be charged each time a user activates, prints or clips a coupon. By way of another example, an advertiser may be charged a flat or a percentage fee for coupon functionality 1830.

The coupons 1830 described above may be conveyed on a network, in whole or in part, by data signals. These manufactured data signals may be of any type and may convey the coupons 1830 on any type of network. For instance, the coupons 1830 may be conveyed by electronic signals propagating on electronic networks, such as the Internet. Wireless communications techniques and infrastructures also may be utilized to convey the coupons 1830.

What has been described above are examples of the subject invention. It is, of course, not possible to describe every conceivable combination of components or methodologies, but one of ordinary skill in the art will recognize that many further combinations and permutations of the subject invention are possible. Accordingly, the subject invention is intended to embrace all such alterations, modifications and variations that fall within the spirit and scope of the claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of charging advertisers a fee for a second ad space, comprising:
providing one or more ads from a plurality of different advertisers in a first ad space, the first ad space maintained by an ad space supplier;
receiving a user input identifying at least one of the ads in the first ad space;
providing a second ad space for a supplemental ad, the supplemental ad having supplemental advertising information relating to the at least one ad identified by the user input; and
charging an advertiser associated with the supplemental advertising information a fee based on receiving the user input.

2. The method of claim 1, wherein the fee associated with the second ad space is at least one of a flat fee, a fee per activation, a fee per clip, a fee per print and a percentage fee, the percentage fee being based on the fee paid by the advertiser associated with the supplemental advertising information for an ad provided in the first ad space.

3. The method of claim 1, wherein charging the advertiser associated with the supplemental advertising information based on receiving the user input comprises charging a fee each time the user input identifying the at least one ad in the first ad space is received.

4. The method of claim 1, wherein the ad space supplier is at least one of an email service, an application program, a web portal, and a search engine site.

5. The method of claim 1, wherein the user input is a hover and the fee is charged if the hover occurs for a minimum period of time.

6. The method of claim 1, further comprising:
determining the fee according to a competition among at least some of the plurality of different advertisers.

7. The method of claim 6, further comprising:
limiting the number of second ad spaces available to the plurality of different advertisers participating in the competition.

8. The method of claim 6, wherein determining the fee according to the competition among the plurality of different advertisers comprises employing a probability that the user input will be received.

9. The method of claim 1, further comprising:
receiving one or more additional user inputs relating to the supplemental ad, the one or more additional user inputs activating one or more additional ad spaces; and
determining the fee according to the number of additional ad spaces activated by the one or more additional user inputs.

10. The method of claim 9, wherein determining the fee according to the number of additional ad spaces activated by the one or more user inputs comprises employing a probability that the one or more additional user inputs will be received.

11. The method of claim 1, wherein the method is encoded by computer-executable instructions stored on computer-readable media.

12. The method of claim 1, wherein the method is performed by computer-executable instructions conveyed by a manufactured data signal.

13. A system for monetizing a secondary advertisement activated by a user, the secondary advertisement relating to a vendor, comprising:
an electronic advertisement conveyed to a user in an ad space provided by a third party;
a secondary advertisement occurring upon receiving a user indication, the secondary advertisement providing associated information relating to the electronic advertisement and thereby facilitating the user's interaction with the vendor; and
a monetizing component, the monetizing component determining the price of the secondary advertisement.

14. The system of claim 13, wherein the monetizing component determines the price of the secondary advertisement by an auction.

15. The system of claim 14, wherein availability of the secondary advertisement is restricted.

16. The system of claim 13, wherein the secondary advertisement is a menu of links, the user indication is a hover over and determining the price of the secondary advertisement comprises:
determining a hover rate, the hover rate being associated with the likelihood the user indication will be received; and
determining a click-through-rate for each link in the menu of links, the click-through-rate being associated with the likelihood the user will click on the link in the menu of links.

17. The system of claim 13, wherein the third party is at least one of an email server, an application program, a web portal, and a search engine web page.

18. The system of claim 13, further comprising:
a tertiary advertisement, the tertiary advertisement occurring upon receiving a second user indication, the second user indication relating to the secondary advertisement, wherein the monetizing component further determines the price of the tertiary advertisement.

19. The system of claim 13, wherein the system is conveyed by a manufactured data signal.

20. A system for determining a cost of advertising in a third party online advertising venue, comprising:
means for providing online advertisements from two or more separate advertisers to a user interacting with the third party online advertising venue;
means for providing a second advertisement, the second advertisement associated with at least one of the online advertisements;
means for receiving a user indication from the user, the user indication corresponding to the at least one online advertisement associated with the second advertisement, wherein upon receiving the user indication, the means for receiving the user indication signals the means for providing the second advertisement to provide the second advertisement and wherein the means for providing the second advertisement provides the second advertisement to the user in response to the signal from the means for receiving the user indication; and
means for determining a cost of the second advertisement.
